(19) United States
(12) Patent Application Publication
(10) Pub. No.: US 2017/0055070 A1
(43) Pub. Date: Feb. 23, 2017

(54) Amplifying device for a wired headphone microphone

(71) Applicant: Barsin F. Khorshid, Van Nuys, CA (US)

(72) Inventor: Barsin F. Khorshid, Van Nuys, CA (US)

(21) Appl. No.: 14/829,616

(22) Filed: Aug. 18, 2015

(51) Int. Cl. H04R 1/34; H04R 1/10; G10K 13/00

(52) U.S. Cl. CPC H04R 1/342; G10K 13/00; H04R 1/1041; H04R 1/1083

(57) ABSTRACT

A funnel like, or any shape like amplifying device that attaches, manufactured, built on or around a wired headphone ear-piece microphone that clamps on to the bottom and/or top of the headphone microphones wire that will fit any cellphone, smart phone, tablet, lab top, etc., device to amplify the users voice/sound and drown out unwanted noise like wind, cars, fans, etc. The funnel like amplifier can be made in any shape, form, materials, color, size, texture etc. and made of two different types of materials as one.

### REFERENCE

Cross reference checks proved that this product is unique and similar and/or other patents do not exist. No product or attachment on or off the market is able to amplify and clearly focus on the microphone's voice on a microphone connected to a wired headphone, headset, speaking device, etc.

### BACKGROUND OF THE INVENTION

The present invention has been designed to focus on amplifying the microphones voice for the listener on the other end of the wired cellphone headset. Currently many cell phone users will not use a blue tooth wireless headset due to radiation and the inability to listen to stereo music from a smart phone. The usage of wired headset has become more popular and consumers understand the safety aspect of using wired over wireless. Mini Amp solves a huge problem that all wired headsets have, the microphone is away from the mouth and open to background noise, if you're on the move, the microphone's voice will not be clear and loud. Using the funnel like invention that clips around the microphone connected to the wired headset will amplify and enhance the microphone's voice and drown out any background noise. This process will cause the microphone's voice to be amplified and enhanced. Mini Amp is a product that will help consumers of wired headset/headphone for all cell phone, smart phones, tablets, or any kind of speaking/listening devices that is able to use a wired ear phone headset/headphone with a microphone connected to the wire. Mini Amp amplifier is very easy to attach to any headset microphone due to the clips on the edge of each side of the Mini Amp that the microphone is connected to. The locking mechanism using clips or any other locking system designs that locks the two pieces around the microphone, creating an cone like shaped amplifier set around the microphone connected to the wired headphones with the large opening facing up towards the microphones mouth and the smaller end will be attached to the wire at the bottom end of the microphone using clips or any other locking or attaching mechanisms to securely lock the invention around the microphone phone. The Mini Amp can have rubber like inserts and/or attachments on each side to push or squeeze the headset microphone phones battens/volume controls while the Mini Amp is attached to the wired headset microphone.

### SUMMARY OF THE INVENTION

Present invention relates to a sound amplifier device designed for a wired headset/headphone with a microphone attached to the wire. Considered broadly, the “Mini Amp is a device of nearly any shape or size and constructed of any soft, hard, elastic, transparent, rubber, metal, plastic, sound amplifying, sound canceling, etc., materials that surrounds and/or covers the area of, within, or near the microphone of a wired headphone, ear piece, or speaking and hearing device. Once attached around to, or built on to the headset microphone of a wired headphone, ear piece, or speaking and hearing device, the Mini Amp amplifies, enhance, buffers, improves and affects the integrity of the voices or sounds passed through, around, above below or within it headset microphone. The user has the ability to use all functions of the headset microphone while the Mini Amp is in place. The user can also remove or leave the device in place or manually move, slide, or adjust the attached device upward, downward to gain the best desired effect.

### BRIEF DESCRIPTION OF DRAWINGS

FIG. 1 shows a side view of the Mini Amp headphone amplifier attachment and what materials can be used to make the product and how it works once attached or manufactured on to the headphone microphone.

FIG. 2 shows a top/side view looking in/side of the Mini Amp amplifier and explains how the bottom grips the wire once placed on to the headphones microphone and how it can be adjusted to slide up and down the wire. The device can also be used as a platform for any kind of advertising and marketing.

FIG. 3 shows the Mini Amp amplifier fully attached or manufactured on to a wired headphones microphone connected to a smartphone/electronic device and will explain how the user will use the headphones and how the device will amplify the user's voice.

FIG. 4 shows the Mini Amp amplifier from a side view with it being opened and having the headphone microphone being placed in to it. This fig will explain the process of attaching the device to the headphone microphone and how it opens and closes with the closing mechanism. This fig will explain how the closing mechanism will be added to the device and the type of material that can be used and what closing mechanism or designs can be used to lock the device into place. This fig will explain the clamping/locking mechanism designed to hold the device on to the wire at the lower end of the headphone microphone in an upright position and or whatever positions the users feels it can be most efficient or comfortable. This fig will also explain how the user can still push the volume/control buttons that are on the headphone microphone through the Mini Amp amplifier due to the soft like materials from which it will be made.

FIG. 5 shows the Mini Amp amplifier from a side view and it has been cut in half with the microphone of the wired headphone in the middle. This image will show how the device can be designed in many ways to be attached to the microphone of the wired headphone. On the top inside right and left of the device will have a stick like attachments that will have a sticky, soft, clicking, magnetic, etc. mechanism on the end that can be used to lock in the microphone by clamping on to the wire of the microphone from both sides once the two pieces of the device are clipped, attached, etc., together. This process will prevent the microphone from moving around while the device is attached. The way this design of the Mini Amp locks in around the microphone is the magnetic, sticky, clicking, clipping, Velcro, etc. materials that will be placed on the edge of each end of the split in half device. The left/right side will have clicking, sticking, clipping, Velcro, magnetic, etc. materials as a locking mechanisms and the bottom end will also have the same sticky, clicking, clipping, Velcro, magnetic, etc. materials so the bottom of the wire of the microphone will be locked in place once the two split pieces of the device are closed it will hold in the microphone in place. FIG. 5 and FIG. 4 way of closing and opening can be mixed together to come up with other designs and methods of locking the microphone of the wire into the Mini Amp.

FIG. 6 shows the Mini Amp amplifier outside view of the volume control. The volume control can be made with plastic, rubber, glass, metal etc. materials or any combinations of. It can be made in any shape, form or colors with or without buttons. The outer buttons can be designed as a circle, square, one long slit, etc. shapes that can be protruding out or in or not at all. The outer rubber, plastic, etc. material will function as an extension of the wired headsets volume control buttons. This will give the user full control and functionality of the wired headsets volume control while the Mini Amp is attached or in place.

FIG. 7 shows the Mini Amp amplifier inside view of the volume control. The inner volume control can be made with plastic, rubber, glass, metal etc. materials or any combinations of. It can be made in any shape, form or colors with or without buttons. The outer buttons can be designed as a circle, square, one long slit, etc. shapes that can be protruding out or in or not at all. The outer rubber, plastic, etc. materials will function as an extension of the outer buttons of the Mini Amp to grip and/or push the wired headsets volume/functionality buttons while the Mini Amp is attached or in place. These inner buttons of the Mini Amp can be made in any shape, form, size, colors etc. to fit any size wired headset microphone volume/functionality buttons. These inner buttons will be pushed into the wired headset volume/functionality buttons when the user places enough pressure needed to push the outer buttons into the wired headsets volume/functionality buttons.

### DETAILED DESCRIPTION OF DRAWINGS

The present detail description will explain more about the figures and or drawing of the Mini Amp amplifier. How the invention will be used, attached and or manufactured on to the wired headphone microphone. It will explain the different types of locking/closing mechanisms and the different types of materials used to make the locking or closing mechanisms and will explain what materials the Mini Amp amplifier will be made of as well. It will explain how the user can still use all functionality of the wired headphone microphone while the Mini Amp amplifier is attached and how the device can be used as a marketing/advertising platform as well. It will explain how the Mini Amp can be adjusted once attached or manufactured on to the wired headphone microphone and how user friendly the entire process is.

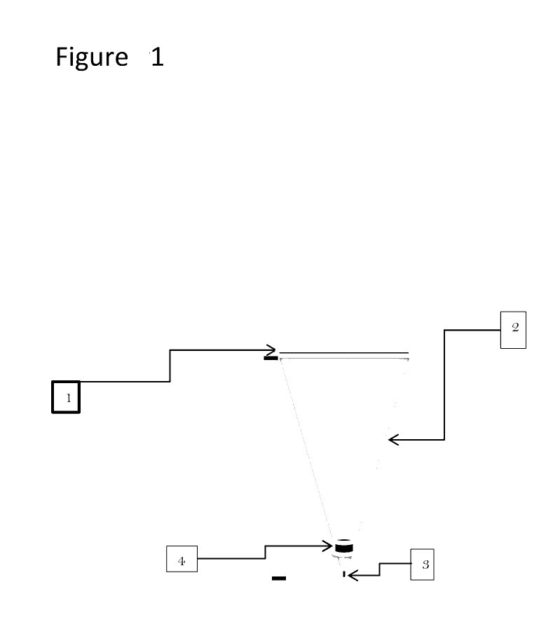

FIG. 1 this figure shows the Mini Amp amplifier 2 from a side view and how the voice enters from 1, and amplified due to the funnel like shape that can be changed to any other shape example circle, triangle, square, etc. The wired headphone microphone inside 2 and will receive the users voice louder and clearer due to the funnel shape design. 2 will be held on to the wire of the headphone microphone by 4, the clamping, closing, pinching mechanism or design placed into or out of 2, where/then wire will exit out of 3. The process of making 2, can be made out of any kind of material for example metal, foam, plastic, cardboard, paper etc., or any sound protecting/filtering/amplifying materials. 2 can be hard or soft made in any color shape and or form to fit a headphone wired microphone. 4 can be attached/manufactured/built onto or into 2. 4 can be made from any kind of materials for example metal, plastic, magnetic, Velcro etc., or any locking closing sticking materials.

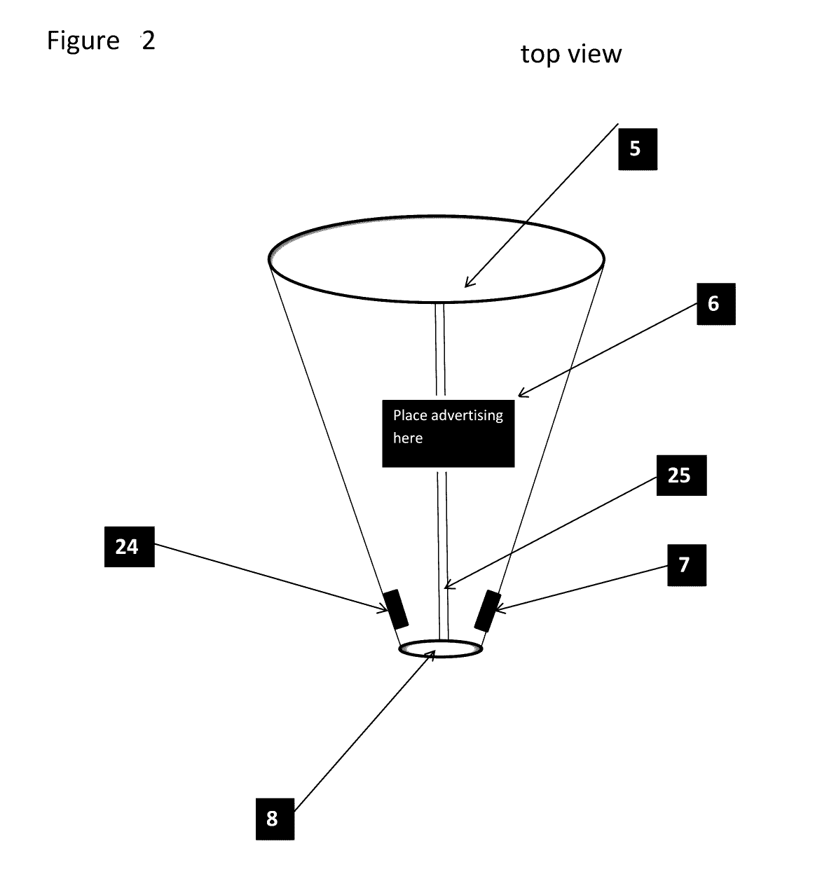

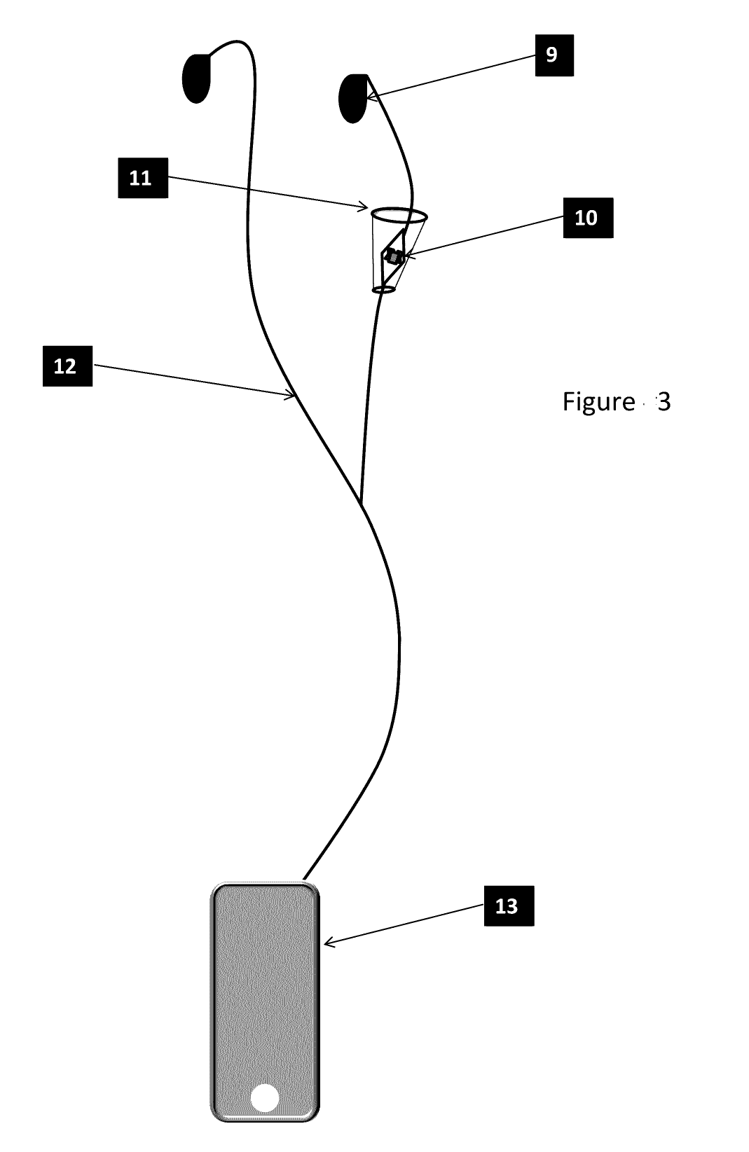

FIG. 2 this figure shows the Mini Amp from an up top and side view angel. 5 is where the microphone of the wired headphone is placed in and where the voice/sound of the user gets amplified. 6 is the location or locations where any first, 2^{nd} and 3^{rd} party company can place marketing/advertising ads to promote themselves or others if approved by the inventor. 7 and 24 is the closing/clamping, sticking, magnetic, etc., mechanism, contraption etc., which can be opened and closed by the user's fingers. Putting pressure on 28 the empty gap between 7 and 24 this will separate the sticky, magnetic, etc., mechanism, so the user/microphone can slide (2 of FIG. 1 or 11 of FIG. 3) up and down (12 of FIG. 3) for best/comfortable position. To re-clamp 7,24 the user needs to release the pressure on 28 between 7,24 and the sticky, magnetic, etc., mechanism will lock back on to (12 of FIG. 3) connected to (10 of FIG. 3) to keep (2 of FIG. 1 or 11 of FIG. 3) in place and up right. 8 is where the sound, voice, etc., of the user goes through to prevent an echo or distort the sound, 8 is the location where the bottom end of the wire coming out of the headphone microphone will exit from as well.

FIG. 3 this figure shows the Mini Amp amplifier from a side view connected fully to 12 the wired headphone/headset and 12 being connected to 13 the smart phone, tablet, laptop, speaking device, etc. 9 is the earphone connected to 12 and 10 is the microphone/volume control connected to 12 and 11 is the Mini Amp connected to 12 and surrounding 10 to focus on the microphones/users voice/sound to amplify all sounds coming in from the user/microphone voice only. This process will amplify the microphones/users voice/sound and will over power all background noise and make the users voice/sound loud and clear to the listener on the other end of the conversation.

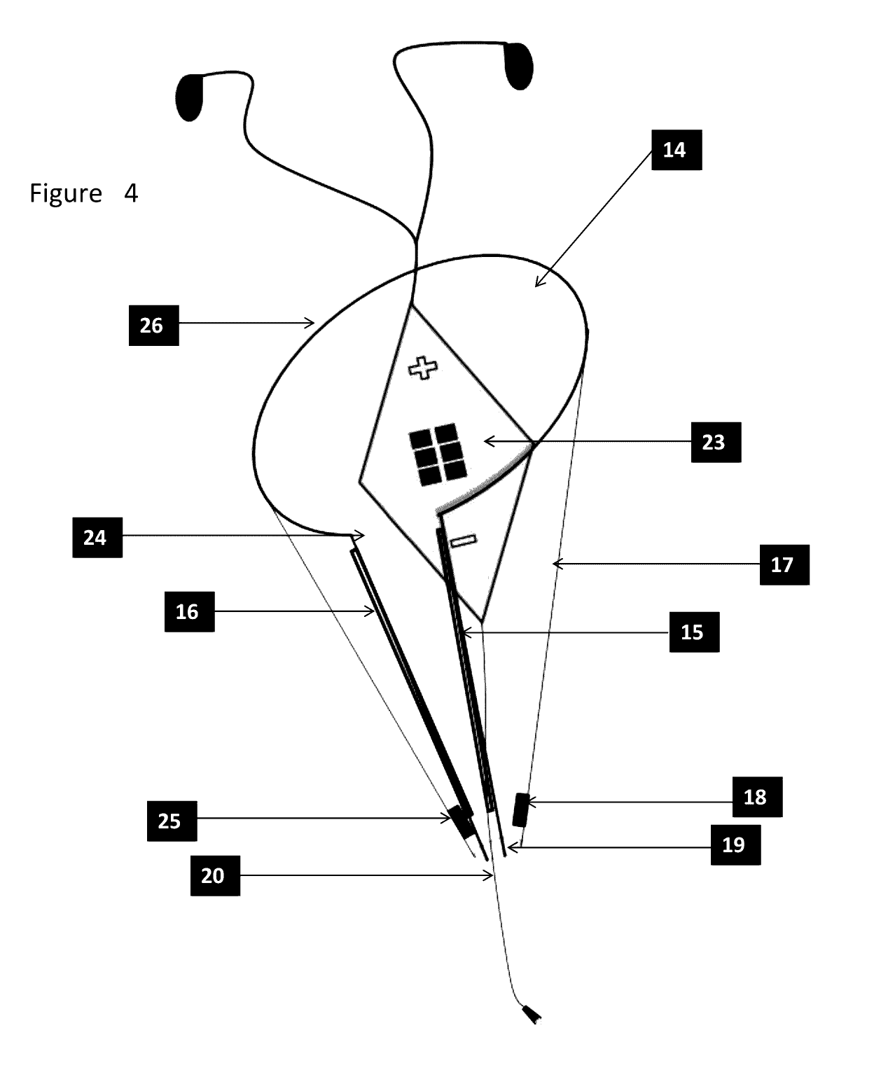

FIG. 4 this figure shows the Mini Amp amplifier from a side view angle and a transparent view looking in to the device while it is open and the headphone microphone is being placed into the device. 27 is the opening of 26 the Mini Amp amplifier and that is where 20 the headphone wire will be pushed through so the 26 can be attached and this process can be done by the manufacture of the wired headphone microphone company so it already comes attached in the package before being sold or by the user after purchasing the device. Once 23 the microphone/control panel is placed in 26 entering 27 the user can close 26 by clamping, connecting, attaching, closing, clicking, etc., 16 and 15 the magnetic, sticking, Velcro, plastic clipping, etc., closing mechanisms once 26 has been closed around 23 and 20, then 20 the wire of the headphone has exit 19 the hole on the bottom of 26 the user can pinch, put pressure, etc., on 25 and 18 the magnetic, sticking, Velcro, clipping, clicking etc., locking mechanisms will lock together, example shown how in FIG. 2 to lock in the 26 firmly in place. The inner 14 and outer 17 sections of the 26 can be made from the same or different materials, example 14 can be plastic and 17 can be rubber or both can be the same. 14 and 17 can be made from any type of soft, hard, elastic, transparent, rubber, sound amplifying, sound canceling, etc. materials. 14 and 17 can be manufactured with information, text, photos, images, etc., placed onto either sections as a platform for logo, advertising, marketing etc. the advertising, marketing, logo, etc., information can be added after the device has been manufactured. Example the information can be added as a sticker, laser, paint, spray, etc., after the process of manufacturing the device or during.

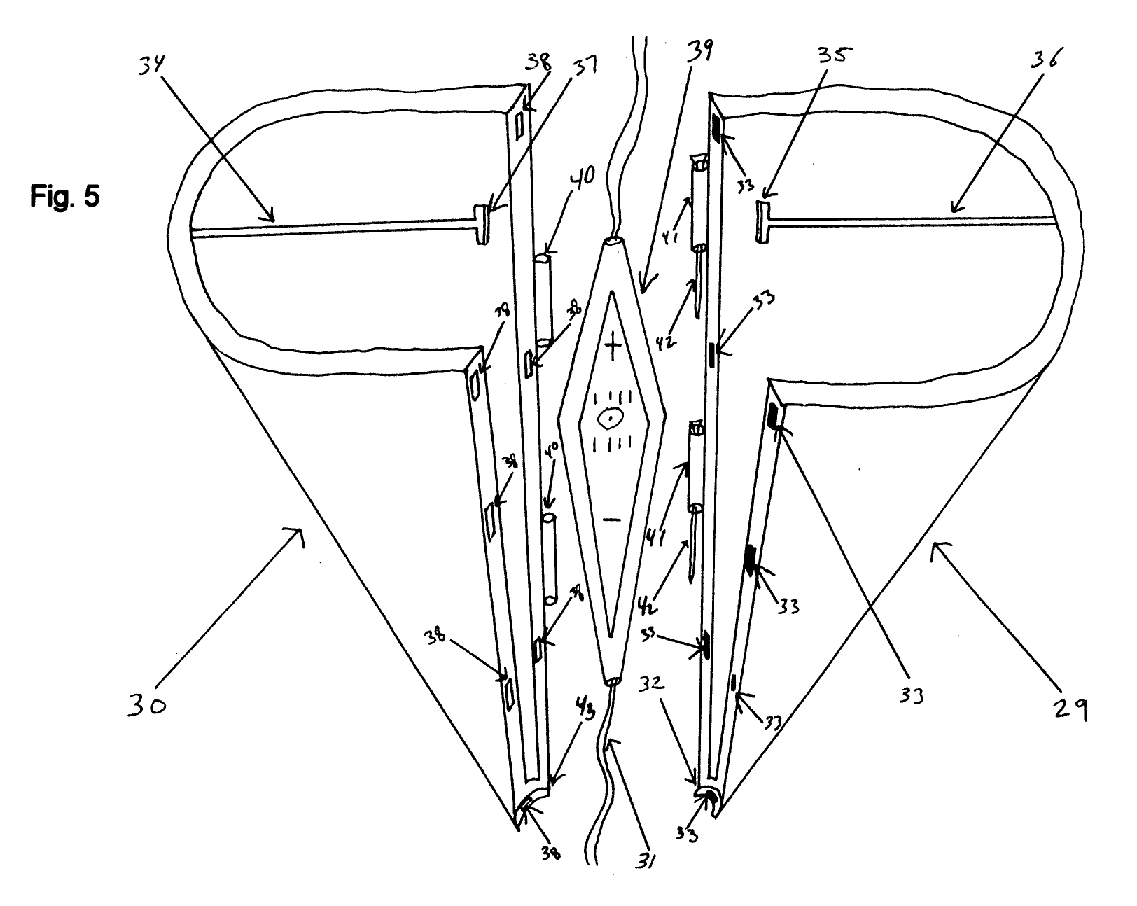

FIG. 5 this figure shows the Mini amp amplifier from a side/split in half view. 30 is the left side of the device and 29 is the right side of the device. The two pieces can be completely separated or can be linked together by using the hinges 40 and 41. Both side can have hinges build on so 30 and 29 can be attached on one end by 40 and 41 and locked in place by 42 the screw, metal, plastic, etc., object and this process will open and close the Mini Amp in a butterfly like motion and will lock the Mini Amp around 39 by using 30 and 38 as the locking mechanism. The other way 30 and 29 can be locked in place is by using 38 a metal, magnetic, plastic, Velcro, etc. hole, object, built/attached on 30 to link, attach, click, lock, etc. in place with 33 the magnetic, plastic, Velcro, plastic, Velcro, etc. material build/attached on to 29 the right side of the device. 30 and 29 will have two locking mechanisms for the wire of the microphone headphone located on the top end 36,34 and on the bottom end 32,43. On the bottom end of 30 and 29 will have 43 and 32 made out of a sticky, soft, gelatin, rubber, Velcro, magnetic, etc. material to grip the exiting wire tightly in place once 30 and 29 has been closed on to 39 the microphone/controller of the headphone. On the top end of 30 and 29 the ends of 36 and 34 will have 37, 35 a sticky, soft, gelatin, rubber, Velcro, magnetic, etc. material to hold the top end of the entering wire of the microphone tightly in place so when 39 is in place between 30 and 29 it will not hit or rub against the device for better sound quality.

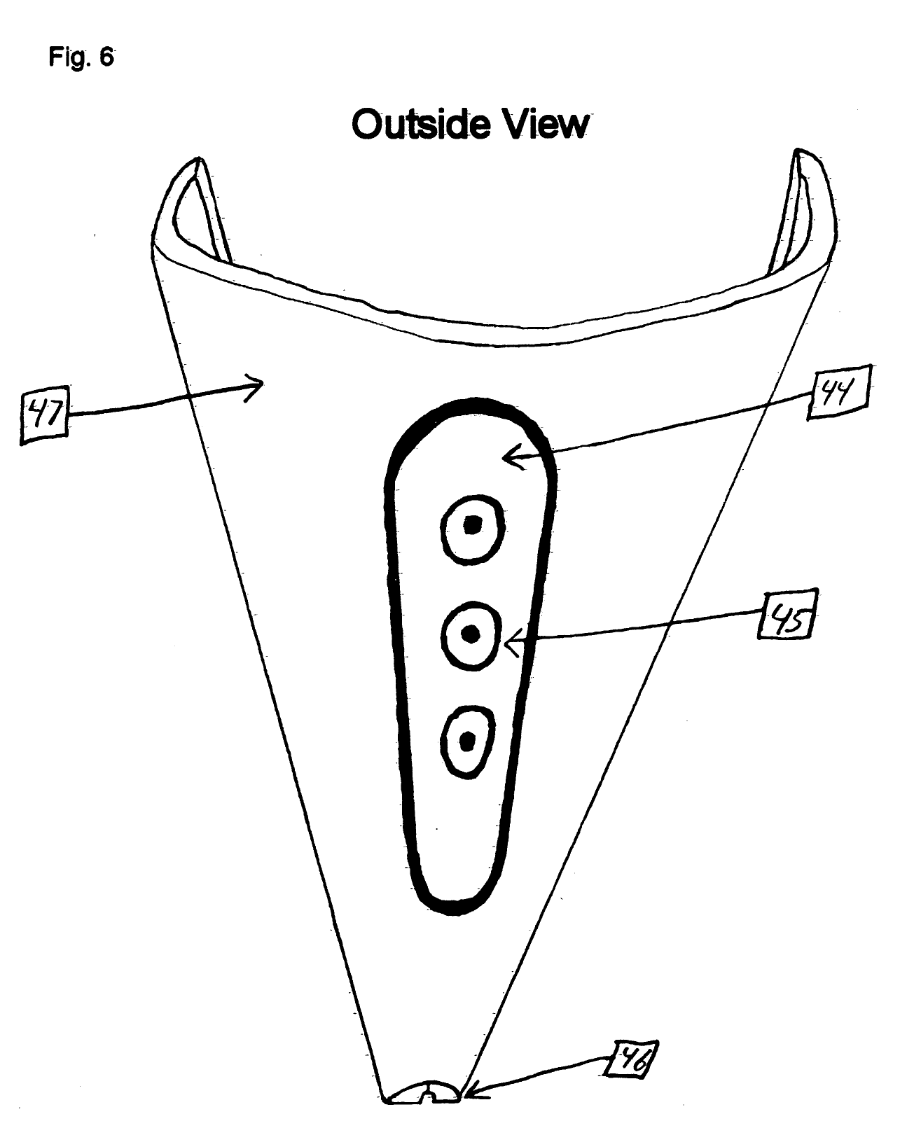

FIG. 6 this figure shows the Mini Amp outside view of the volume control. 44 is the rubber, plastic etc. material that can be soft and or hard. 45 is the button/buttons that can be made from any material, shape, form, size, color etc. as a pushing mechanism to control the wired headphone volume control/functionality buttons. 46 is the rubber, plastic etc. material bottom opening of the Mini Amp that will grip and or lock the wire of the wired headphone to keep the Mini Amp in place. 47 is one of the outer side of the Mini Amp that can be made with any material. 44 and 45 can be made with the same material or two different types of materials.

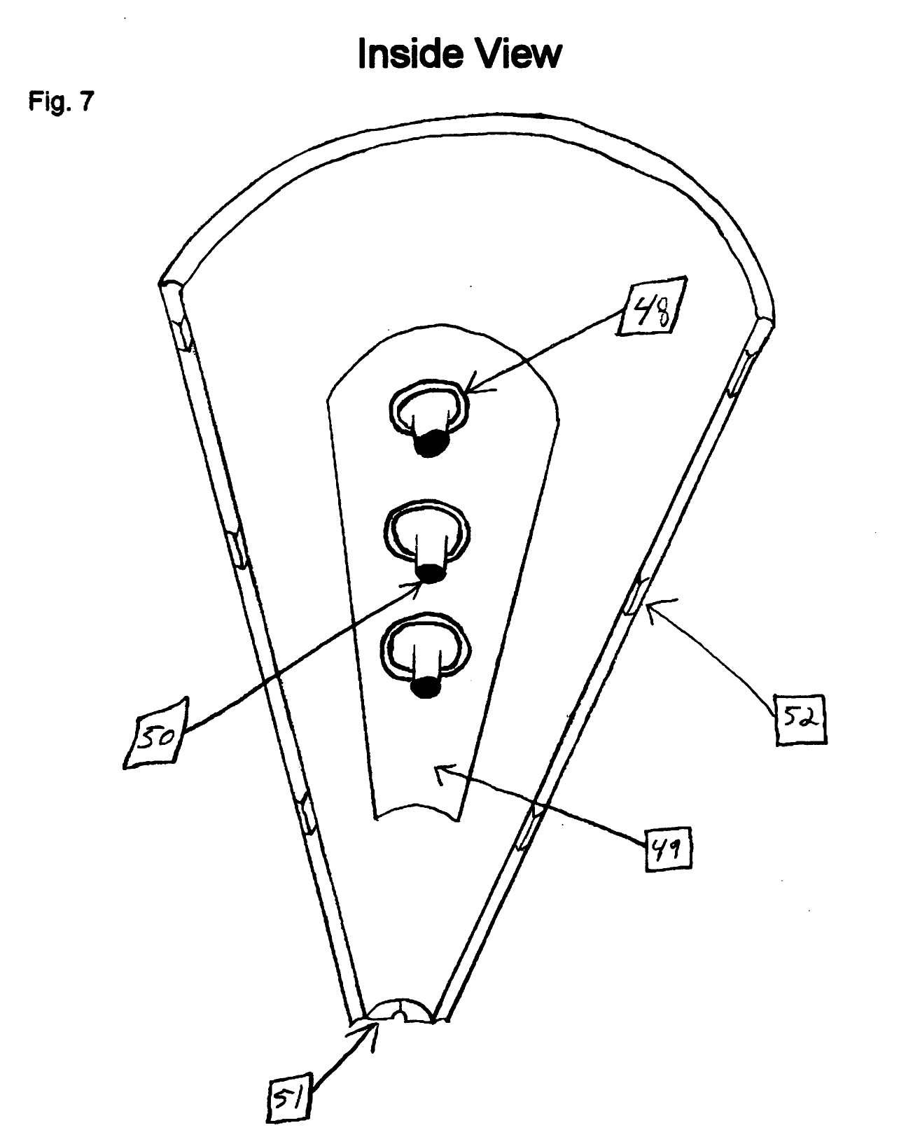

FIG. 7 this figure shows the Mini Amp inside view of the volume control. 49 is the inside view of the rubber, plastic, etc. material that can be soft and or hard. 50 is the inside view of the extension of 45. 50 will be protruding out and or on to the microphone, volume control/functionality buttons of the wired headphone. 50 will also grip, clamp, hold, keep in place, etc. the wired headphone microphone, volume control/functionality buttons in place. 48 is the inside view of the rubber, plastic, etc. material rim of 50. 48 can be made of softer material to give 50 room to be pushed in and out. 50 can function without the use of 48 as well. 51 is the inside view of the rubber, plastic, etc. material that will grip, hold, clamp, etc. the wire of the wired headphone to attach, clip, place etc. the Mini Amp on to the wired headphone. 52 is the inside view of the clicking, attaching, clamping, griping, locking, etc. mechanism that will keep both pieces of the Mini Amp in place/around the wired headphone microphone, volume control/functionality battens.

What is claimed is:

1. The Mini Amp is an amplifying device for a wired headphone microphone comprising:
a. A funnel shaped cone that wraps around the microphone connected to the wired headphone, headset, earpiece, etc., and amplifies the users voice/sound;
b. The funnel shaped cone can be split in two or be a one piece device that will be attached to the wire of the microphone by the use of magnetic, Velcro, clicking, gripping, etc. mechanisms at the bottom and or top end of the device, this can be adjusted so the device can slide up and down the wire of the headphone for best positioning for the user;
c. The funnel shaped cone will have an opening on one and or two sides where the wire will enter from the opening. The openings will close and or lock by the use of magnetic, Velcro, etc. materials, clicking, clamping, gripping, etc. mechanisms by user and or automatically;
d. The funnel shaped cone can be made of any material, color, shape, form, texture, size, etc., to fit the microphone connected to the wired headphones;
e. Whereby a person can clip, attach, connect, link, etc. the device to the microphone and or volume control/functionality of the wired headphone to amplify the voice of the user and drown out the unwanted noise like wind, background talk, cars, fans, etc.;
f. The user can still use all functions of the microphone/sound control connected to the headphone due to the soft or hard like materials used to make the device or add on buttons/soft sections to the (Mini Amp) funnel shaped device that will grip, link, reach and or push to the headset microphone's volume controls/functionality connected to the wire to be used as one;
g. This device can be manufactured onto the wired microphone or be attached after\manufacturing process of the wired microphone;
h. The device can also be used as a marketing and or customizable platform to promote logo, text message, images, holograms, lights, decorative objects, colors, etc.
